(19) United States
(12) Patent Application Publication
(10) Pub. No.: US 2003/0134599 A1
(43) Pub. Date: Jul. 17, 2003

(54) Field technician assistant

(76) Inventors: David M. Pangrac, Port Aransas, TX (US); Donald T. Gall, Port Aransas, TX (US); Steven W. Rose, Haliimaile, HI (US)

Correspondence Address: H. Dale Langley, Jr., Law Offices of Gary R. Stanford, 610 West Lynn, Austin, TX, 78703, US

(21) Appl. No.: 10/215,206

(22) Filed: Aug. 8, 2002

Related U.S. Application Data
(60) Provisional application No. 60/310,976, filed on Aug. 8, 2001.

(51) Int. Cl. H04B 17/00

(52) U.S. Cl. 455/67.4; 455/67.1

(57) ABSTRACT

An electronic device configured as a technician assistant for a field technician of a broadband telecommunications network. The Tech Assistant includes a processing device, a memory that stores applications for execution by the processing device, a technician assistant application for loading into the memory, a display, and at least one input device. The technician assistant application is executed by the processing device and includes network-specific information combined with generic technical information to assist the technician to identify any of several network problems and to diagnose and resolve any of the network problems. The technician assistant application may further incorporate a design module that assists a field technician with creating a new network or network extension. The input device(s) facilitate selection and control and the display displays technician assistant selection and result information.

### CROSS-REFERENCE TO RELATED APPLICATION(S):

The present application is based on U.S. provisional patent application entitled “Field Technician Assistant”, Serial No. 60/310,976, filed Aug. 8, 2001, which is hereby incorporated by reference in its entirety.

### FIELD OF THE INVENTION

The present invention relates to broadband telecommunications networks, and more particularly, to an electronic technician assistant that assists a technician in the field.

### BACKGROUND OF THE INVENTION

Field technicians for broadband telecommunication networks are tasked with many responsibilities to solve the problems that arise in the field. Such job responsibilities may include, for example, setting up networks and diagnosing and repairing network problems associated therewith. In many cases, field technicians are not properly trained and do not know how to set up test equipment or how network systems are supposed to work. Technicians are typically trained on the job. Network systems and corresponding network problems associated therewith are sufficiently complex so that troubleshooting network problems is a difficult task even for experienced technicians.

Most technicians, including the most experienced technicians, encounter new situations that challenge the technician's knowledge and may even lead to improper diagnosis and repair. Field test equipment may be changed and/or upgraded and the technician may be unfamiliar with the new or modified equipment. For any technician, reference material must often be consulted even by the most experienced technicians, such as network maps, specifications, test and/or troubleshooting procedures, test equipment setup and use, etc. Such reference information is invaluable but is usually not readily available in the most convenient form. Furthermore, it is possible to be an experienced technician with generally good practice skills but lacking a complete understanding of the RF theory behind broadband telecommunication network operation. Such knowledge significantly enhances the quality of performance.

It is desired to provide a convenient field tool to enhance the experience and performance of all field technicians regardless of experience level, training level or familiarity with specific network systems and/or test equipment.

### BRIEF DESCRIPTION OF THE DRAWINGS

For a more complete understanding of the present invention, reference is now made to the following description taken in conjunction with the accompanying drawings in which like reference numerals indicate like features and wherein:

FIG. 1 is a front view diagram of an exemplary handheld computer device that may be employed to operate as a technician assistant according to an embodiment of the present invention.

FIG. 2 is a simplified block diagram of an exemplary embodiment of the hardware configuration of the handheld computer device of FIG. 1.

FIG. 3 is a block diagram of exemplary functional modules of technician assistant software according to an exemplary embodiment of the present invention that may executed on the computer device of FIG. 1 or any other suitable computer device.

FIGS. 4A-4D collectively illustrate an exemplary form and content tree for the technical assistant software.

FIGS. 5A-5E are exemplary screen shot diagrams illustrating initial page and exemplary test equipment (Tektronix RFM 151) setup information for measuring C/N.

FIGS. 6A-6B are exemplary screen shot diagrams illustrating another exemplary test equipment (Tektronix 2714/15) setup information.

FIGS. 7A-7B are exemplary screen shot diagrams illustrating an exemplary stored System Map Grid and map portion.

FIGS. 8A-7F are exemplary screen shot diagrams illustrating exemplary troubleshooting information for calculating distortions, CNR and CTB.

FIGS. 9A-9B are exemplary screen shot diagrams illustrating exemplary test procedure with stored C-Cor manual.

FIGS. 10A-10B are exemplary screen shot diagrams illustrating exemplary Reverse (from subscriber to central location) Problems and Causes Information.

FIGS. 11A-11D are exemplary screen shot diagrams illustrating exemplary Tutorial information.

### DETAILED DESCRIPTION OF EMBODIMENTS OF THE INVENTION

The present invention is an electronic device employed to assist and support a field technician in resolving broadband telecommunication service problems, deficiencies, interruptions, etc., typically initiated by calls from subscribers of the services. Such broadband telecommunication services may include, for example, any combination of cable television, video services, broadband Internet access or access to any global communication network, telephony services, etc. A technician assistant or “tech assistant” according to the present invention is not intended to replace the technician or even to replace measurement equipment typically used by field technicians. Instead, the tech assistant is a field support device that incorporates network-specific information combined with generic technical information configured in a handy format to substantially enhance the ability of each technician to perform his or her job more efficiently. In one embodiment, the tech assistant is configured as a menu-driven system operated on a computer-based device that enables the technician to quickly and easily identify and access specific information of interest. The tech assistant may be handheld so that the technician can carry and use the unit anywhere and at any time.

The tech assistant includes an application that incorporates any number of modules, sections or knowledge libraries, each designed to provided valuable information on particular broadband telecommunication subjects and/or particular aspects of a selected network to assist the technician in resolving network problems and/or service interruptions. For example, the tech assistant may incorporate a network system map that assists the technician to locate and identify certain equipment, components or devices in a specific network such as a specific cable plant. Such network maps may be pre-loaded or downloaded while in the field from a remote or central location. A wired or wireless communication link is contemplated for sending or receiving data and information. The tech assistant may include specification information of equipment, media and devices of specific networks or generic network configurations. The specification information may be updated separately or further tied in with the maps portion and updated with a new network map to include specifics of the equipment used in that particular network configuration. The tech assistant may include a diagnostic guide that incorporates expert information for each of primary service types. The expert information includes, for example, an exhaustive list of particular communication problems and proposed solutions or diagnostic procedures for resolving each problem. The tech assistant may incorporate setup and use guides for each of standard or specifically identified test and measurement equipment used in the field. The tech assistant may include various electronic tools, such as calculator applications and the like to assist the technician in making, converting and analyzing measurements or determining certain network parameters, such as, for example, radio frequency (RF) losses on a specific length of a specified type of coaxial cable. The tech assistant may include one or more tutorials to assist in training the technician on a variety of subjects from specific equipment to general network operation and to help the technician understand or troubleshoot network problems associated with a particular subject. For example, a tutorial may be provided to help a technician understand and troubleshoot digital cable signals that are transmitted through a cable television system. The tech assistant may include contact information of individuals who may be able to assist in any aspects of the technician's responsibilities. Of course, any particular tech assistant configuration may include any one or more of these capabilities depending upon the needs of the technician or the configuration of a particular network or cable plant.

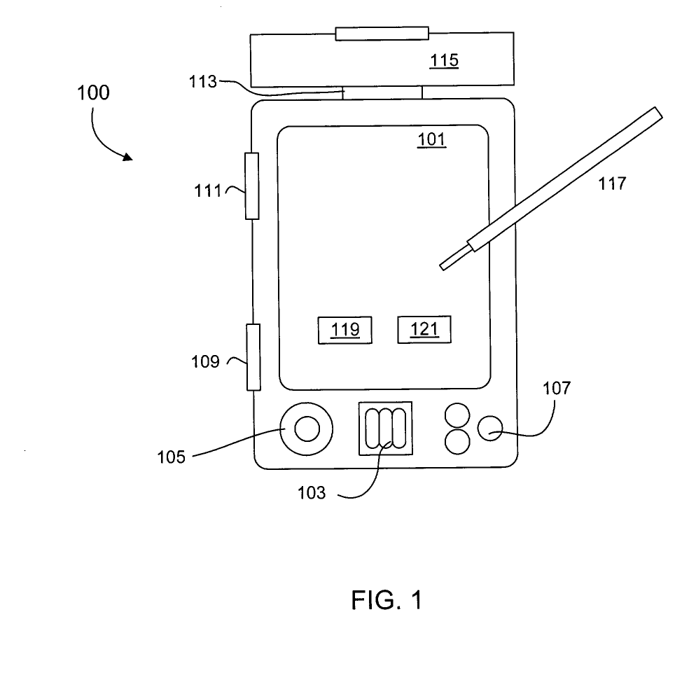

FIG. 1 is a front view diagram of an exemplary handheld computer device 100 that may be employed to operate as a technician assistant according to an embodiment of the present invention. The computer device 100 includes a display 101 and various other optional input/output (I/O) devices, such as a speaker 103, one or more physical buttons including navigation buttons 105 or application buttons 107, one or more I/O ports 109 (e.g., USB, infrared, etc.), a memory expansion slot 111, an I/O adapter port 113 or the like for receiving and connecting a specialized I/O device 115, etc. The specialized I/O device may be any type of attachment, such as a digital camera (with or without video capability) or a bar code reader, etc. The display 101 is implemented in any desirable or suitable format, such as a liquid crystal display (LCD). In one embodiment, the display 101 includes touch screen capabilities with sensors for determining interaction with a pointer 117. For example, an application program running on the computer device 100 displays one or more graphic buttons or icons 119, 121, and the touch screen sensor detects selection of the icon 119 by the pointer 117 and takes the appropriate action or displays a predetermined or calculated result.

The computer device 100 illustrated is an exemplary pocket PC embodiment, such as a Cassiopeia by Casio, Inc., the iPAQ configurations by Compaq Computer Corporation, the WorkPad by IBM, etc. The Pocket PC has many desirable attributes that are advantageous for purposes of the present invention, such as interactive I/O interfaces, sufficient memory storage size and processing capabilities for storing, loading and operating tech assistant software, and a convenient size for handheld operation for portability and ease of use. Other pocket PCs or handheld computer type devices are contemplated. The device may be a general purpose device that is programmed for specific tech assistant operation, such as the Pocket PC using Windows CE by MicroSoft Corporation or any other suitable or standard operating system. Alternatively, the device may be dedicated and designed specifically for tech assistant functionality. For example, a tech assistant device using a pre-programmed or dedicated tech assistant chip-set and targeted I/O type functionality is contemplated. The handheld attribute is desirable in that the unit may be conveniently carried by the technician for use almost anywhere and any time, such as while diagnosing a problem on top of a telephone pole. A handheld device is not absolutely necessary, however, and other, larger configurations are contemplated for certain uses and environments. For example, laptop or notebook configurations are contemplated and considered to fall within the scope of the present invention.

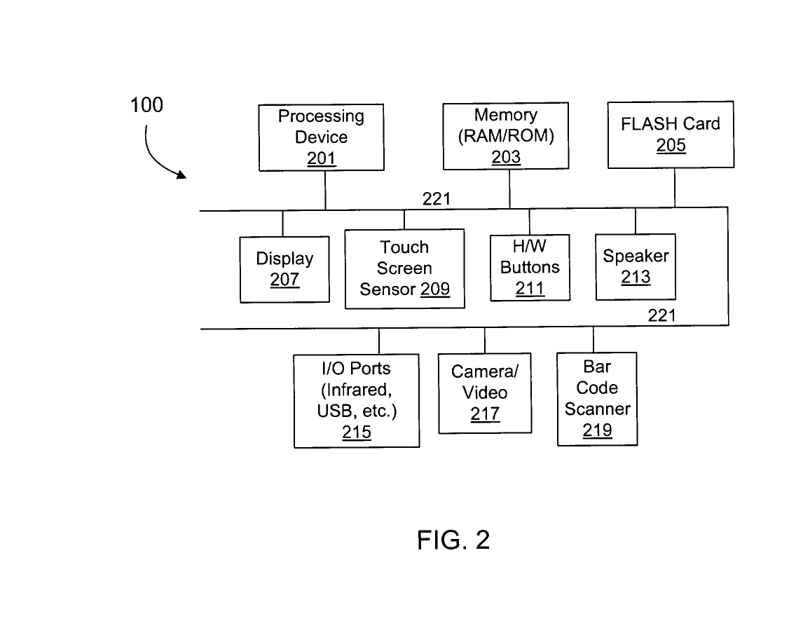

FIG. 2 is a block diagram of an exemplary embodiment of the hardware configuration of the computer device 100. The computer device 100 includes a processing device 201, such as a separate microprocessor, an a microcontroller, etc., coupled to one or more memory devices 203 across an appropriate bus or interface structure 221. Embedded systems including an embedded processor are contemplated. The memory 203 includes any combination of read-only memory (ROM), random access memory (RAM) and the like for static and/or long-term storage of software applications and data, and for loading applications for execution by the processing device 201. Many variations are possible and contemplated for the hardware. For example, the computer device 100 may have memory expansion capabilities, such as receiving a separate FLASH memory card 205 or the like for expanding application memory. The computer device 100 includes any suitable type of I/O devices and peripherals, such as a display interface 207 for operating the display 101. The display 207 may include touch screen functionality, such as including touch screen sensors 209 for detecting interface between the pointer 117 and the display 107. The I/O devices may include any number of button interfaces 211 for detecting activation of the physical buttons 105 or 107, a speaker interface 213 for operating the speaker 103, any number of I/O port interfaces (e.g., infrared, USB, etc.), and any type of special equipment interfaces, such as appropriate camera 217 or a bar code reader 219 interfaces. Communication interfaces may be implemented using an I/O port or a separate interface to enable wired or wireless communications. Such communication provides access to remote information or to a remote or central location (e.g., cable system headend), for accessing desired information (e.g., a network system map), or to upload data acquired in the field to a central location.

Although the exemplary configuration shown in FIG. 2 includes specific components indicative of handheld equipment, it is also representative of other configurations, such as notebook or laptop computers or the like. For example, a laptop computer would include a processor 201, memory 203, display 207, H/W buttons 211, speaker 231, I/O ports 215 among other components and may further include other components as necessary, such as appropriate camera 217 or a bar code reader 219 interfaces. A primary difference with larger and/or greater capacity computers is the user interface. The display or monitor of a laptop computer or the like is larger than typical handheld devices so that any one or more of the various screen shots can include more information and options. In fact, a central menu screen is employed for a laptop/notebook embodiment providing links to most or all submenus and capabilities from a single location rather than requiring multiple submenu layers. Also, several tasks can be opened at once employing multitasking or windowing capabilities.

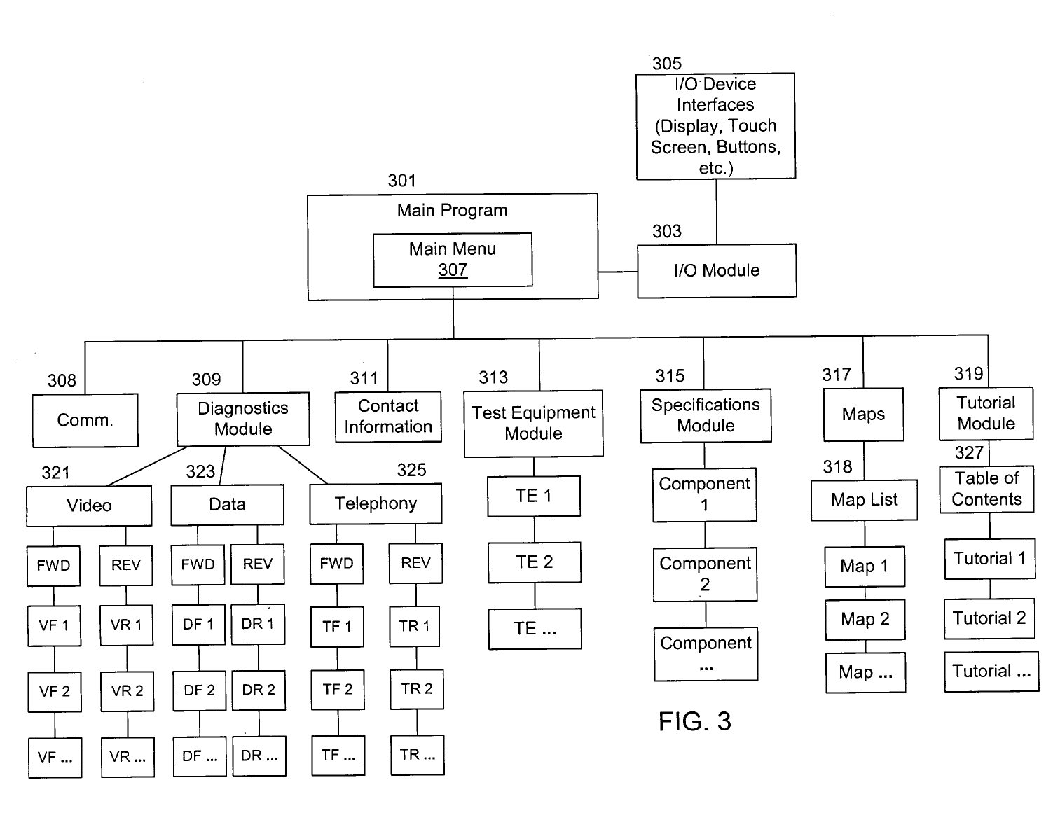

FIG. 3 is a block diagram of exemplary functional modules of technician assistant software according to an exemplary embodiment of the present invention that may executed on the computer device 100 or any other suitable computer device. In the embodiment shown, the tech assistant software application is a menu-driven application including a main program 301 that is loaded upon selection by the user. The application may be implemented in any suitable manner depending upon the host device or configuration, such as any combination of software, firmware, hardware, etc. The main program interfaces an I/O module 303, which further communicates with the I/O device interfaces 305 for enabling I/O interface and control. In this manner, the application detects programmed input, such as pressing of a button or selection of a graphic icon on the display 101 by the pointer 117, and provides programmed outputs, such as selected sounds via the speaker 103 and graphics via the display 101, etc. The I/O module 303 is not necessarily part of the tech assistant software but instead provides standard interfaces to the I/O devices. The main program 301 calls up and displays a main menu 307, that further displays one or more primary menu categories and corresponding icons for selection by the user. In the graphic icon environment, each icon may include an explanatory label indicating the information associated therewith. Each primary menu category links to one or more submenu modules, each including one or more “pages” or screen shots of display information and/or one or more submenu icons further linking to submenu selections. In this manner, the user is able to easily navigate the menu-based software application to access desired information in a fast and efficient manner.

In one embodiment, the primary menu icons link to a communication module 308, a diagnostics module 309, a contact information section 311, a test equipment module 313, a specifications module 315, a maps section 317 and a tutorial module 319. It is noted that the particular menu categories shown are exemplary only and that particular configurations may each include any combination of the illustrated options and may further include additional selections not shown. Each module may be considered “optional” for particular configuration, although any given configuration would usually include at least one of the modules to achieve the corresponding functionality. The communications module 308 is provided for those configurations in which it is desired to access information from remote locations or from a central location, such as a headend of a cable plant network. The communications module 308 is configured in any manner to enable the technician to access desired information, such as a cable plant-specific map, or to send information acquired in the field, such as diagnostic information obtained at a subscriber location, a bar-code reading, a camera shot or video depicting a communication problem, etc. Online access is contemplated, such as providing access to web pages on the world wide web (WWW), access to a network-specific server, etc.

The diagnostics module 309 assists a technician with the fundamentals of troubleshooting a problem with a selected system, such as a cable television system, and includes several submenu module selections including a video module 321, a data module 323 and a telephony module 325. The video, data and telephony modules 321, 323 and 325, each include a forward (FWD) selection list for diagnosing downstream information (information sent to a subscriber/customer) and a Reverse (REV) selection list for diagnosing upstream (information received from a subscriber by a central location, such as a headend). Each of the FWD and REV selection lists further include selectable entries to specific troubleshooting guides associated with the selected module. For example, the FWD list associated with the video module 321 includes one or more Video Forward (VF) selections VF 1, VF 2, . . . , and the REV list associated with the video module 321 includes one or more Video Reverse (VR) selections VR 1, VR 2, . . . . In a similar manner, the FWD list associated with the data module 323 includes one or more Data Forward (DF) selections DF 1, DF 2, . . . , and the REV list associated with the data module 323 includes one or more Data Reverse (DR) selections DR 1, DR 2, . . . , and the FWD list associated with the telephony module 325 includes one or more Telephony Forward (TF) selections TF 1, TF 2, . . . , and the REV list associated with the telephony module 325 includes one or more Telephony Reverse (TR) selections TR 1, TR 2, . . . . As described further below, each of the FWD and REV selection lists indicate a specific problem description, the selection of which links to corresponding solution(s) for each diagnostic module area. It is noted that each FWD and REV selectable item may be further associated with one or more screens or pages of information or may further include additional submenu items for selection by the user.

The contact information section 311 includes one or pages of contact information of persons or entities that may assist the technician in the use of the tech assistant and/or in diagnosing a network problem or provide information associated with the specific network of interest.

The test equipment module 313 includes one or more predetermined test equipment (TE) selection icons TE 1, TE 2, . . . , where each selection icon links to further information regarding the setup and use information of the selected equipment. Each equipment icon may link to a specific piece of equipment or may indicate a manufacturer of one or more test equipment components commonly used or pre-loaded into the tech assistant application. Each icon is labeled with an equipment or manufacturer identifier. For example, in the latter manufacturer identifier case, selection of the test equipment module 313 icon links to a page displaying multiple icons, each labeled with a specific manufacturer of test equipment, such as “H.P.” (Hewlett-Packard Company), “Wavetek”, or “Tektronix”, etc., and may further include one or more customizable links for a particular user. Selection of the “Tektronix” icon links to a page with one or more specific equipment icons, each labeled with a corresponding piece of test equipment manufactured by Tektronix, Inc., the selection of which links to specific equipment information. The equipment information may include, for example, a graphic picture of the equipment and descriptive information of the selected equipment. An equipment page may further include one or more setup and use icons for setting up and using the equipment to make certain measurements or to perform certain tests. The tech assistant software may be pre-loaded with specific information on any equipment of choice.

The specifications module 315 provides links to specification information of equipment, media and devices of specific networks or generic network configurations. The specifications module 315 includes a specifications page that links to specific component information, individually shown as Component 1, Component 2, etc. Components within the specifications module 315 may be organized by type, such as those associated with the system, those having certain attributes (passive or active), those associated with certain media types (coaxial cable, fiber optic cable), etc.

The maps module 317 links to a map list page 318 that lists one or more system maps of networks or cable plants supported by the user, shown as Map 1, Map 2, . . . , such as cable television network maps or the like. A typical map may include, for example, the location, characteristics and various parameters of network devices, equipment and components in a specified geographic area of a specific cable plant, along with subscribers and subscriber locations in the area. Each map may further include location of network cables and corresponding distances of each cable section. Each map enables the technician to locate and identify system components and cables in the network and to compare measurements with specified values and parameters. Maps may involve a relatively large geographic area and include a substantial number of components, equipment and subscribers, whereas the display 107 may be relatively small. Thus, the map section may include zoom, pan and selection features to enable easy navigation and display of map portions.

The tutorial module 319 links to a table of contents page 327, which further includes a list of specific tutorial icons that link to pre-loaded tutorials, shown as Tutorial 1, Tutorial 2, . . . , each on a selected topic associated with broadband telecommunications. Each tutorial provides step-by-step training information to assist in the training and understanding of the technician regarding basic, intermediate or advanced network concepts. For example, the tutorials may include training and information regarding digital cable signals, network impairments affecting quality of network signals, test equipment basics and fundamentals of basic equipment types (e.g., oscilloscopes, spectrum analyzers, TDR, etc.), signal transmission fundamentals, etc.

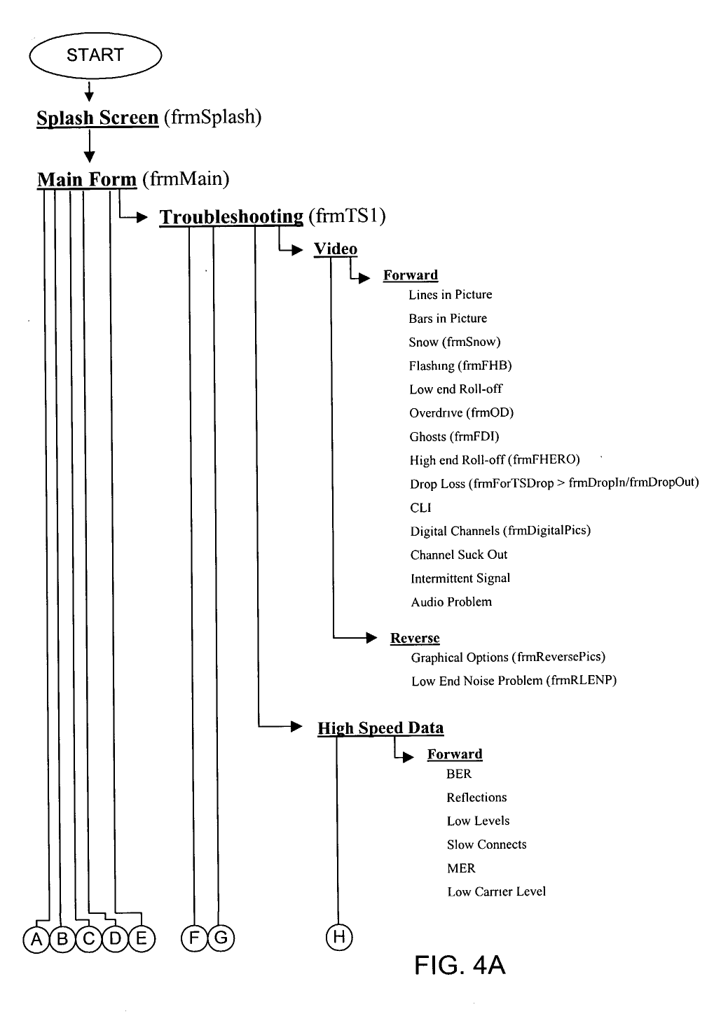

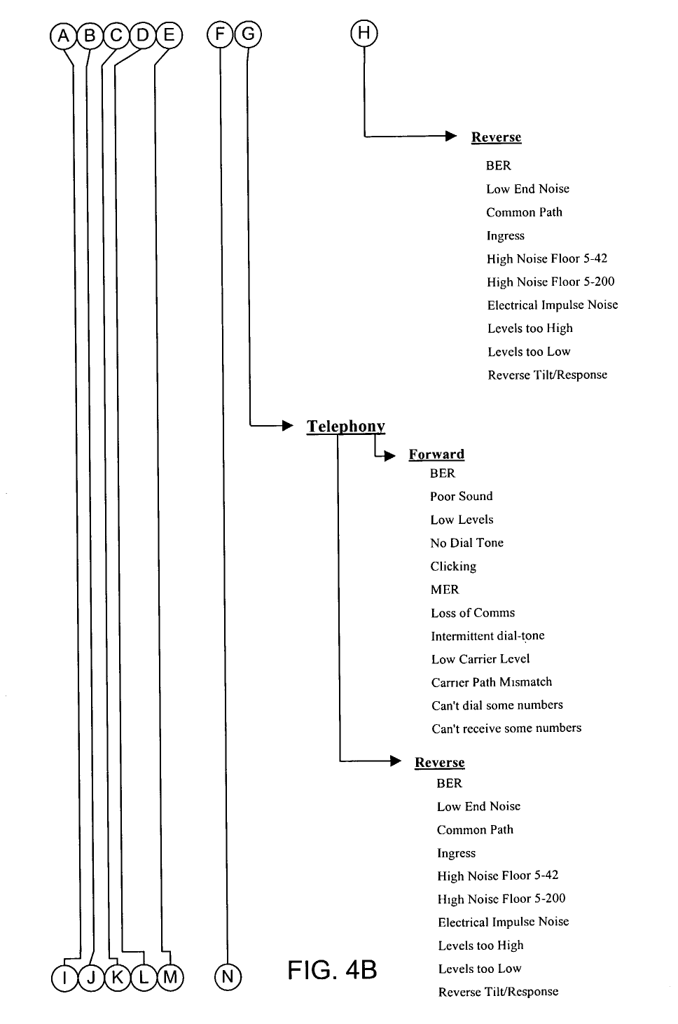

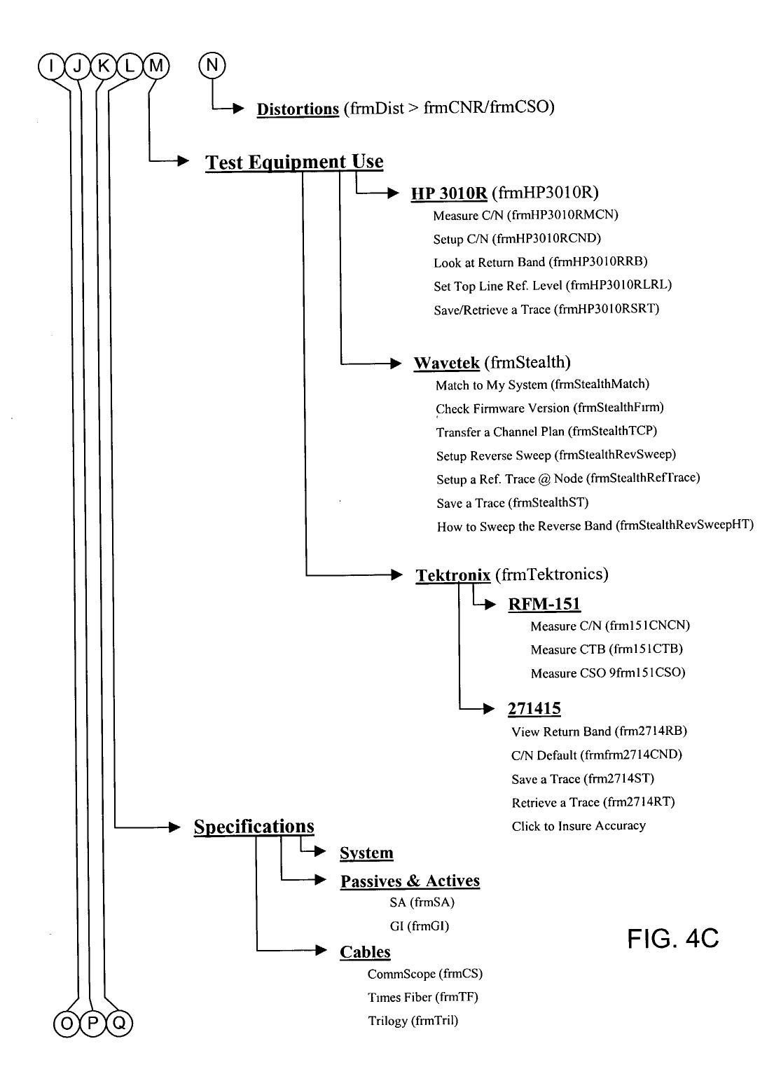

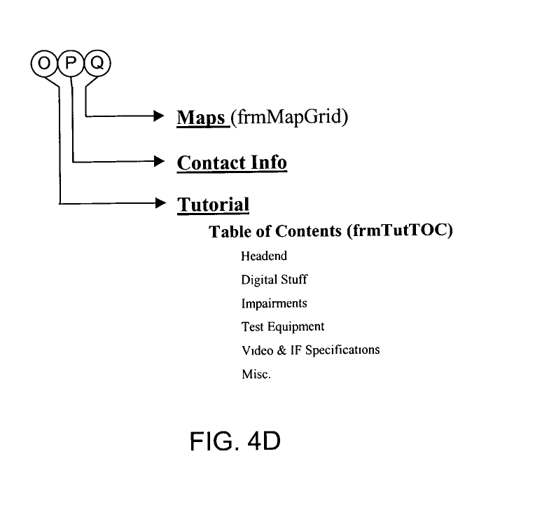

FIGS. 4A-4D collectively illustrate an exemplary form and content tree for the tech assistance software. The tree spans multiple pages and includes circular alphabetical off-page connectors for connecting branches of the tree from page to page. Upon initiation of the tech assistant software, an optional “Splash Screen” is temporarily displayed while the program is loading. The Splash Screen provides general information about the software, its source and any other general information, such as copyright notices and the like. The Splash Screen may also provide a forum for version information or information about the particular network operator of the target network or cable plant. The program proceeds to a “Main Form” menu page, which includes selectable graphic icons or tabs of the main modules of the tech assistant application. The configuration shown includes a “Troubleshooting” tab (corresponding to the diagnostics module), a “Test Equipment Use” tab, a “Specifications” tab, a “Maps” tab, a “Contacts” tab, and a “Tutorial” tag, which generally correspond to the modules 309, 313, 315, 317, 311 and 319, respectively, as previously described.

Selection of the “Troubleshooting” tab displays an “Options” icon (not shown) for further accessing a trouble shooting page with selectable icons, including a “Video” icon, a “Data” icon (e.g. High Speed Data), and a “Telephony” icon. The diagnostics module 309 also includes a “Distortions” icon (FIG. 4C) that links to a program for calculating the distortions of an amplifier in a cable TV system. In the embodiment illustrated, the troubleshooting page further includes two pull down-menu selection lists, one for “Forward” (downstream) and one for “Reverse” (upstream). The user may select any of the icons listed on the troubleshooting page, and may then select any individual item within either the “Forward” list or the “Reverse” list. Each list includes multiple problem descriptors, such as describing characteristics observed by a subscriber or that describes the type of service interruptions. Selection of a technology area defined by sub-modules 321, 323 and 325 and further selection of any “Forward” or “Reverse” item within that sub-module, as provided below, links the user to resolution information, such as additional pages with solution information, submenu selections, calculation programs, etc., designed to enable the technician to identify a network problem and to lead the technician to a solution in a step-by-step manner.

The “Forward” list associated with the video module 321 includes “Lines in Picture” indicated by a bunch of lines that are displayed by a subscribers cable television (TV), “Bars in Picture” indicated by fat horizontal lines, “Snow” indicating no cable TV signal, “Flashing” indicated by the TV picture flashing on and off, “Low end Roll off” occurring when the cable TV picture looks bad on the lower channels, “Overdrive” indicated by a bunch of lines throughout the TV picture caused by too much signal present at an active device, “Ghosts” indicated by a double image on a TV channel, “High end Roll-off” indicated by the higher channels looking bad, “Drop Loss” describing a program that is used by the technician to calculate how much TV signal exists at a subscriber's TV, “CLI” describing help and troubleshooting aids to identify cable TV signals that are incorrectly transmitting into the airwaves (e.g., a cable TV system is a closed system), “Digital Channels” describing channels that are digitized and compressed so that more channels can be transmitted throughout a cable TV system, “Channel Suck OUT” indicated by one or more and less than all channels looking bad, “Intermittent Signal” indicated by the cable TV signal being turned on and off, and “Audio problem” indicated by unclear or scratchy sound on the subscriber's TV set. This and other “Forward” lists are exemplary only and not intended to be an exhaustive list of all possible problems that may be encountered. The “Reverse” list associated with the video module 321 includes “Graphical options” including graphic pictures of cable TV system problems, such as pictures depicting actual spectrum analyzer screen shots, and “Low End Noise Problem” including actual pictures of types of problems that can occur on the RF return. Again, this and other “Reverse” lists are exemplary only and not intended to be an exhaustive list of all possible problems that may be encountered.

The “Forward” list associated with the data module 323 (High Speed Data) includes “BER” linking to a specification that describes the bit error rate occurring in a transmitted data stream, “Reflections” describing a phenomenon in which desired RF signals take multiple paths through a single transmission medium causing interference to be present within a digital data stream at the receive terminal, “Low levels” describing a condition where a signal level is below the level necessary to function as intended, “Slow connects” describing lower than expected throughput and/or system response time observed in a data transmission system, “MER” linking to a specification that describes a degree of error in a received RF signal when compared to the transmitted RF signal, and “Low carrier level” describing a condition where an RF signal level is below the level necessary to function as intended. The “Reverse” list associated with the data module 323 includes “BER” describing a specification that describes the bit error rate occurring in a transmitted data stream, “Low end noise” describing a condition in which a higher amount of noise energy than expected is present in the lower frequencies of the upstream transmission path, “Common Path” describing a form of interference usually created by malfunctioning coaxial cable distribution systems that can adversely affect upstream signal transmissions, “Ingress” describing a phenomenon in which undesired radiated energy enters a coaxial cable transmission medium by defeating or circumventing the cable shielding, “High noise floor 5-42” describing a condition in which the measured noise energy within the specified upstream frequency spectrum (associated with frequency range 5-42) is greater than expected, “High noise floor 5-200” describing a condition in which the measured noise energy within the specified upstream frequency spectrum is greater than expected (this condition is usually an indication of a damaged or dirty fiber optic connection at the return fiber optic transmitter), “Electrical impulse noise” describing a phenomenon in which undesired radiated energy originating in electrical devices enters a coaxial cable transmission medium and pollutes desired signal transmissions within the cable system, “Levels too high” describing a condition in which RF signal power levels are greater than the levels necessary to function as intended, “Levels too low” describing a condition in which RF signal power levels are lower than the levels necessary to function as intended, and “Reverse Tilt/Response” describing a signal level measurement survey employing a comparison of the RF signals and/or gain and attenuation characteristics at various frequencies within the upstream frequency spectrum.

The “Forward” list associated with the telephony module 325 includes “BER” describing a specification that describes the error bit rate occurring in a transmitted data stream, “Poor sound” describing a condition where the sound quality is objectionable, “Low levels” describing a condition where a signal level is below the level necessary to function as intended, “No dial tone” describing a condition in which telephone subscriber equipment that is requesting network access is unable to do so, “Clicking” describing a condition where, during the course of a telephone conversation, audible clicks are unintentionally embellished that are objectionable, “MER” describing a specification that describes a degree of error in a received RF signal when compared to the transmitted RF signal, “Loss of comms” describing an alarm condition that signifies a loss of communications between two or more terminals, “Intermittent dial-tone” describing a condition in which telephone subscriber equipment requesting network access is not able to do so on each attempt or is interrupted during some or all attempts, “Low carrier level” describing a condition where an RF signal level is below the level necessary to function as intended, “Carrier Path Mismatch” describing a condition in which a signal transmission that is intended for a specific terminal does not reach it or is received with an inferior quality that prevents it from being identified by the receive terminal as a valid communications channel, “Can't dial some numbers” describing a condition in which telephone subscriber equipment requesting network access and attempting to establish a communications link are consistently able to do so with some destinations but consistently unable to do so with other destinations, and “Can't receive some numbers” describing a condition in which telephone subscriber equipment is consistently able to establish a communications link with some originators but consistently unable to do so with other originators. The “Reverse” list associated with the telephony module 325 includes “BER” describing a specification that describes the rate of errors occurring in a transmitted data stream, “Low end noise” describing a condition in which a higher amount of noise energy than expected is present in the lower frequencies of the upstream transmission path, “Common Path” describing a form of interference usually created by malfunctioning coaxial cable distribution systems that can adversely affect upstream signal transmissions, “Ingress” describing a phenomenon in which undesired radiated energy enters a coaxial cable transmission medium by defeating or circumventing the cable shielding, “High noise floor 542” describing a condition in which the measured noise energy within the specified upstream frequency spectrum is greater than expected, “High noise floor 5-200” describing a condition in which the measured noise energy within the specified upstream frequency spectrum is greater than expected, “Electrical impulse noise” describing a phenomenon in which undesired radiated energy originating in electrical devices enters a coaxial cable transmission medium and pollutes desired signal transmissions within the cable system, “Levels too high” describing a condition in which RF signal power levels are greater than the levels necessary to function as intended, “Levels too low” describing a condition in which RF signal power levels are lower than the levels necessary to function as intended, and “Reverse Tilt/Response” describing a signal level measurement survey employing a comparison of the RF signals and/or gain and attenuation characteristics at various frequencies within the upstream frequency spectrum.

Selection of the “Test Equipment Use” tab displays a page with graphic icon links to informational pages of one or more specific test equipment. Each equipment icon may link to a specific piece of equipment or may indicate a manufacturer of one or more test equipment components commonly used or pre-loaded into the tech assistant software. Each icon is labeled with an equipment or manufacturer identifier. For example, one or more of the icons may be labeled with a specific manufacturer of test equipment, such as “H.P.” (HewlettPackard Company), “Wavetek”, or “Tektronix”, etc., and may further include one or more customizable links for a particular user. The equipment information may include, for example, a graphic picture of the equipment and descriptive information of the setup and use of the selected equipment for performing specific functions. It is noted that generic equipment descriptions may be provided for operation of general types of equipment, such as “Oscilloscope” or “Spectrum Analyzer” or the like. It may be deemed more useful, however, to provide specific information for specific pieces of equipment. New modules may be written for new pieces of equipment and added to, and modules associated with obsolete equipment may be removed from, the software as desired. The technician simply acquires and pre-loads the appropriate module for the specified equipment that he or she uses in the field. Included herein are a few exemplary procedures for specific types of equipment for purposes of illustration. Of course, these are only exemplary procedures and a more exhaustive list of equipment and/or list of procedures for each piece of equipment may be provided.

In the exemplary illustrated embodiment, one link provides information about the HP 3010R by Hewlett-Packard. This link provides information on how to do an actual carrier to noise (C/N) measurement with the meter, including the procedures necessary to perform the measurement, such as which buttons to press and when. The information includes how to setup the meter to look at the cable TV (CATV) reverse spectrum, how to setup the meter to properly measure a CATV signal, and how to save or retrieve a picture that was saved on the meter.

Another link provides information on the Wavetek 3ST Stealth. This link provides information on setting up the meter to the cable TV system specifications, how to check what firmware version the meter has in case it needs to be updated, how to transfer a channel plan for the target cable TV system from one meter or PC to the meter in use, how to setup the meter to perform system sweep, how to setup a reference trace at a node, how to save a picture of the meter screen, how to setup and perform system sweep on the reverse band (the signals going to the headend from the subscribers), etc.

Another link provides information on the Tektronix RFM-151. This link provides information on how to do an actual carrier to noise measurement with the meter, how to do an actual composite triple beat measurement with the meter, how to do an actual composite second order (CSO) measurement with the meter, etc.

Another link provides information on the Tektronix 2714/15. This link provides information on how to setup the meter to look at the CATV reverse spectrum, how the meter is actually going to take the carrier to noise measurements without any changes to the setup, how to save a picture of the meter screen, how to retrieve a picture of the meter screen, etc. The information also includes cautionary information for particular meters, if necessary, such as a warning to click to insure accuracy in order to conduct proper measurements with the meter.

Selection of the “Specifications” tab displays a page with a separate icon or link for each of multiple specification categories, such as those associated with the user's specific network configuration (e.g. “System”), specific component types (e.g. “Passives & Actives”), media types (e.g. “Cables”), etc. A “System” icon may link to specification information of network components specific to the network system that the technician is supporting. A “Passives & Actives” icon links a list of specific components organized in any desirable manner, such as by type and/or by manufacturer (e.g. Scientific Atlantic, General Instrument, etc.), in a similar manner as described above for the test equipment module 313. For example, a selection of “S.A.” links to components manufactured by Scientific Atlantic, such as multiport taps, splitters and DC's. A “Cables” icon links to a list of cable types or manufacturers, which further provides links to specific types of cables used in networks, such as coaxial (coax) cables or fiber optic cables, and the like. The “Cables” section may include, for example, loss information for specific cables and may further include a cable loss calculator (not shown) that computes the amount of loss for a specific length of a specified cable input by the user. In one embodiment, selection of the “Cables” submenu within the “Specifications” tab enables the user to determine RF losses of specific cables from specific manufacturers, such as CommScope, Times Fiber, Trilogy, etc.

The user may also select from among “Maps”, “Contacts” and “Tutorial” tabs to access corresponding information as described previously. An exemplary Tutorial section may include separate tutorials about a cable headend (the facility where cable TV signals are received and then transmitted throughout the cable TV system), digital information, impairments, test equipment, video and intermediate frequency (IF) specifications, and other miscellaneous matters. For example, a tutorial may provide training information that helps a technician understand and troubleshoot a cable television headend, training information that helps a technician understand and troubleshoot digital cable signals that are sent through a cable TV system, training information that helps a technician understand and troubleshoot cable TV system impairments that would affect the quality of the cable TV picture a subscriber would receive, training information that helps a technician understand how to use the test equipment used every day on the job, training information that helps a technician understand how cable television signals are transferred throughout the headend, etc.

During the course of a technician's work, he will encounter many varied tasks, problems and sometimes uncertainties. The Tech Assistant is designed to serve as a versatile tool for the technician to use. It can be used as an educational tool for the inexperienced technician and a reference tool and system calculator for the experienced technician including the most experienced of field staff. There is no specific order in which the Tech Assistant must be used.

The tutorials are meant to give basic knowledge and theory so that procedures and practical applications will make sense and reduce the chance of mistakes. A technician can go through the tutorials in succession or choose only those that he needs help with or he may reference specific parts only when the need arises. Tutorials can also be used as an electronic textbook to train beginning technicians. The advantage to having this in stored electronic form is that the technician will always have access to it when issues arise during routine work.

The reference items and procedural guides are especially meant to be accessed in random order to meet the needs of the moment. The technician can pick and choose between a variety of reference tools on the job. Examples of reference tools include the troubleshooting procedures, specifications, systems maps and contact sections. A list of specifications may be provided to define what levels should be expected at amplifier or tap locations. Troubleshooting tips and calculators may be provided to assist in determining what levels should be at any point in a given network. Systems maps provide instant system mapping and configuration.

A technician will not necessarily know from day to day (or work order to work order) what kind of problem will be encountered. Some measurement procedures come up so seldom that the technician might not remember from the last time which parameters to set on an instrument. The Tech Assistant is loaded with programmed instructions for the test instruments, systems electronics and other devices that are used in the cable system in which the technician works. Since accessing the Tech Assistant is intended to be random, no set procedure can be illustrated to describe the use of this device. Instead, several exemplary scenarios are provided to illustrate how a user would navigate through the stored programs and content of the Tech Assistant to help solve problems and improve the efficiency of field personnel. The following scenarios are exemplary only to illustrate field technicians using a tech assistant device in the field for various service calls, and are not intended as exhaustive illustrations of the capabilities of the tech assistant device. Also, the particular options and/or selections do not necessarily correspond to the exemplary embodiments described herein as each Tech Assistant may be configured in any of several different manners.

John is an average maintenance technician employed by a Cable Television Operator in anywhere, USA. He arrived at the company office this morning and received his share of service calls for the day. His first call is for a specific subscriber at an identified address that is approximately ten miles from the office. The subscriber has called in with “lines and snow in the picture” of his television.

Upon arriving at the subscriber's home John takes a look at the customers television set to observe the problem and attaches his Textronix RM151 Field Strength Meter (FSM) to the coaxial cable connecting the television set to the network. He looks at the levels and decides that he wants to measure the Carrier to Noise (C/N) ratio. For directions he consults his Tech Assistant for instructions on properly setting up the measurement. As described previously, the Tech Assistant incorporates setup instructions for a variety of equipment including pre-loaded information on test equipment of choice. The Tech Assistant advises him that he does not have enough signal level to make a proper measurement. In this manner, the Tech Assistant incorporates sufficient information to enable the technician to determine desired signal levels. In this example, the technician determines that the signal levels are slightly lower than normal but within tolerance. The subscriber has three sets in the house, so at the rear of the house is an unbalanced three-way splitter. John looks up the splitter configuration in the Tech Assistant to confirm which is the “Hot leg”. He also looks up the trouble shooting procedures for Both Lines in the Picture and snow. The Tech Assistant stores sufficient trouble shooting procedures for these common problems. John measures the signal levels at the ground block and verifies that they are slightly low here as well.

At this point the trouble-shooting guide in the Tech Assistant has suggested that the next logical step is to check the nearest amplifier for proper levels. He accesses the system maps stored in the Tech Assistant and finds that the first amplifier is one block away to the north. He also notices that it is the third amplifier in cascade away from the Fiber Optic Node. John goes to the pole where the amplifier should have been and finds it is actually located one pole away. He enters the as-built change in the Tech Assistant. In this manner, the maps are updated with as-built information. Then he consults the Tech Assistant to find the levels and distortions that he should expect at that point in the network. John climbs the telephone pole and pulls up his HP 8591c spectrum analyzer and hooks it on the strand next to him. He consults the Tech Assistant on the correct method for setting up the analyzer to measure distortions. Next he consults the C-Cor manual stored in the Tech assistant for pad, equalizer and test point locations and verifies that the pad & equalizer is correct. While performing measurement, he finds that the levels are correct but that the amplifier is operating outside its normal range. He replaces the amplifier module and sets up the proper levels. He has fixed part of the subscriber's problem. Replacing the line extender module cleared up most of the lines in the picture but did not solve the low signal levels.

John also notices a large amount of noise and beats in the return band. John consults the Tech Assistant for trouble shooting these problems and chooses the proper point in the network to most efficiently locate the problem. At this location he measures signal levels and they seem low. He consults the System maps again for the distance between the line extender and his present location. With this information John accesses the coaxial loss calculator to verify that the level measurement. This confirms that the measurement is not correct for the location and the problem is somewhere in the 350 feet-between the line extender and his present location. As the Tech Assistant coached him earlier, he uses his Trilithic Sniffer Plus (Manual available in Tech Assistant) and finds that there is a signal leak on the next pole back. As per company policy, he uses the CLI dBmV to uV/M Microvolts per Meter calculator in the Tech Assistant and records the level. He climbs the pole and finds a crack in the cable, which he repairs. He checks with the subscriber, who is very happy with his clear picture and goes to his next call.

Jim is a service technician in Waterloo Cablevision. He receives a trouble ticket for Mr. Jones on Avery Street which states that the customer reports grainy pictures. Jim arrives at Mr. Jones house, introduces himself and asks Mr. Jones what the problem is to verify the ticket information. Mr. Jones says that the pictures are snowy. Jim asks to see the television set and observes pictures himself and, sure enough, the pictures are noisy, especially on lower frequency channels. Jim measures signal level on his meter and finds that channel 2 is −16 dBmV and channel 78 (the highest channel) is −2 dBmV. Jim goes out to the street and finds the tap pedestal feeding the house. He removes the drop and finds a signal level of +17 dBmV on channel 78 and +20 dBmV on channel 2. He's not sure if this is reasonable so he consults his Tech Assistant. He goes to Specifications to check tap levels and find that the minimum tap level in this system is +16 dBmV on Channel 78 and +12 dBmV on channel 2. (on Tech Assistant, tap Options, Specifications, System, Tap Levels). Satisfied that he has the minimum levels required, he proceeds to the ground block at the corner of the house. He estimates that there is about 75 feet of cable to this point and it's RG-6. He uses Tech Assistant to calculate the signal level he should have at this point. (on Tech Assistant, tap: Options, Troubleshooting, “to Options”, “calculators drop-down menu”, “Drop Loss, Pick cable type—in this case RG-6, enter tap levels found for channels 2 and 78, enter cable footage of 75 feet and tap Calculate). The Tech Assistant returns the result of 15.9 dBmV on channel 2 and +16.5 dBmV on channel 78. Jim measures the signal level at the ground block and finds that they agree to the calculated value. Immediately following the ground block is a two-way splitter. Jim measures the signal at the output of the splitter and finds that the signal level is −10 dBmV on channel 2 and +5 dBmv on channel 78. (Jim knows that a two-way splitter shouldn't have this much loss but if he didn't, he could use Tech Assistant by going to Options, Specifications, Passives and Actives, Drop Passives). Jim replaces the splitter and resolves the problem.

Mike is a senior technician. He picks up a batch of trouble tickets at the office in the morning and notices that he has two tickets in the same vicinity that both state grainy or snowy pictures. Mike arrives at the first subscriber's home and asks to see the television set. He observes that indeed the pictures are noisy and routinely checks signal level. He finds a rather strong signal level of +8 dBmV on channel 2 and +7 dBmV on channel 78. He then decides to check the carrier to noise ratio (C/N). Mike can't remember what the minimum signal level required is for his meter which is a Wavetek SAM 4040 Signal analysis meter. So he pulls out his Tech Assistant and taps: Option, “Test Equipment Use”, Wavetek, SAM 4040 and C/N. He notes that the meter requires an input level of +10 dBmV for accurate C/N measurements and also reviews measurement procedures. Mikes goes out to the tap pedestal where he will have more signal. Here he measures greater than +17 dBmV on both high and low channels and measures the C/N to be 34 dB. Mike now knows that this is not a low signal problem or a single subscriber problem but is a system noise problem affecting numerous subscribers. He refers to the Tech Assistant again to check maps and see how this area is served. Mike taps: Options, System Maps, chooses the hub area he's in (Wilma), east Trunk and map no. 01-04. Mike sees that this subscriber is fed from fiber node SE-07 and one line extender following it. He proceeds to the fiber node and makes another C/N measurement there and finds that C/N=53 dB. Mike consults the Tech Assistant again and displays the same map grid. He taps the magnify icon and draws a rectangle around the node to enlarge it. He then uses the pan icon to center it and then magnifies it again. He can now tap on “distortion” (icon on bottom tool bar), (window pops up instructing to select object), tap OK on window to close it, tap distortion bullseye next to node and then tap the distortion icon in the tool bar again. A window now appears that gives calculated values for all parameters; C/N, CTB, XMD,CSO and Hum. The Tech Assistant indicates that C/N is calculated to be 51.8 dB so it looks good here. Mike routinely checks other parameters while he is here including output level to ensure that low inputs to the line extender won't be a problem. If Mike isn't sure what output levels should be set at, he can refer to Tech Assistant for system specifications.

Mike then goes to the following line extender, measures C/N and finds that it is only 34 dB at the output of the line extender. He then refers to the Tech Assistant again to check what set-up parameters should be. He taps: Options, System Maps, the correct hub, trunk and grid selection and then magnifies the line extender location so that he can read pertinent information on the tombstone for this line extender. He uses this information to check for proper input and output levels and for proper selection of pads and equalizers. Everything checks out except for the C/N reading which should be 51.1 dB. Mike replaces the line extender module (after notifying dispatch that he's disrupting service) and corrects the problem.

Joe is a system technician and is on stand-by duty for the weekend. On Saturday night, he gets a call from customer service that they are getting numerous calls from Town and Country housing development stating that service is out. Customer service gives Joe the names of the streets affected. Joe notes these down and tells them he'll get right on it. Before leaving home, Joe pulls out his Tech Assistant and refers to the maps. (He taps: Options, System Maps and selects the hub, trunk and grid of concern). He notes that the fiber node is on the corner of Elm and Cherry Streets and that there are two feeder cables leaving that location to feed a total of four line extenders. Joe jumps in his truck and drives to the node in question. At the node, Joe finds everything totally dead. He checks for AC voltage and finds none. A quick check of fuses finds that they are not blown. Joe pulls out his Tech Assistant again and accesses system maps as before and locates the power supply for this area. It's in a pedestal about a block away. When he gets there, he finds that a car accident had occurred and severely damaged the pedestal and the feed from the power company. At this point, Joe realizes he will need help. He again consults his Tech Assistant. He taps: Options, Contact info and retrieves the emergency number for the power company, the construction supervisor of the cable company and his own boss. Help is on the way.

A design module may be included in the Tech Assistant to help a field person design a small project while on site. The design capability is specifically useful for very small cable operators or SMATV operators who do not have central design departments, or for designs of projects that are geographically dispersed and difficult to revisit when design questions arise. In one embodiment, the Design module has two modes, an “As Built Mode” and a “Design Mode”. The “As Built Mode” is used to predict the signal level a technician should read at the place a signal level measurement is being made in an existing network. The “Design Mode” is used to design cable networks or network extensions that do not exist yet need to be built to activate one or more additional subscribers. The Design module program may have options to set different system parameters which can be customized by the user (for example levels to subscriber and system design frequencies). In a specific configuration, selection of a “Design” tab displays a page with buttons for selecting different system passive devices (e.g. “Passives”), different system active devices (e.g. “Actives”), different system cable types (e.g. “Cables”), option buttons for the different design modes (e.g. “As Built Mode” or “Design Mode”), and a grid showing the design as built by the user. The grid shows the device type (e.g. “device”), the footage entered to the next device (e.g. “Footage”), the tap value chosen or automatically selected by the program depending on what mode is selected (e.g. “Tap Value”), and different frequencies and the RF level at those frequencies. A scenario employing an exemplary design module follows.

Norman is the regional technical person for a company that specializes in operating SMATV systems in mobile home parks. Basically, Norman takes care of everything in his area: walkout, design, ordering materials, construction and operation. He has been notified by the Shady Creek Mobile Home Park that they are expanding and will add 22 lots to their existing site. Norman arrives on site and measures off the distances from existing facilities to the new lots. He then accesses the design program on the Tech Assistant to perform the design work.

First, he sets his parameters. He taps: “Options” and then “Design”. A window pops up to ask if this is a new file. If the existing plant is not currently in the Tech Assistant, he taps “yes”, then enters a file name “Shady Creek” and taps “OK”. Before starting design, all design parameters are set. Norman taps “Edit Shady Creek” then “Options” on the pop-up menu. The “General” tab at the bottom is then selected. Norman fills out the boxes that ask for manufacturer choices and the signal level information asked for. Then Normal selects the “Frequency” tab and fills out the required frequency information. Then he taps “OK” at the top right corner.

The design worksheet is now visible. Norman highlights the “Design Mode” button if not already highlighted. To start with an amplifier, he taps “Actives” and then the desired amplifier type in the pop-up window. This displays the available amplifiers at the bottom. Norman selects the one desired by tapping it and notes that it has been added to the worksheet in the device column. To place a tap immediately following the amplifier, he taps “Passives” and selects “Taps” and then the number of ports in the following window. He notes that a tap with the correct dB value has been added to the device column. Now Norman taps “Cables” and the cable type in the pop-up window. To change the manufacturer, Norman taps “Manufacturer” at the top of the window and selects the desired manufacturer. Once the cable type has been selected, the various size cables (diameter) are displayed at the bottom of the worksheet. Norman selects the one he wants. A page is then displayed that asks for length of cable to the next device. Norman enter the length in feet (although any other unit of measurement may be programmed). The length is also entered in the device column. Norman repeats this process for successive taps and cable lengths. The spreadsheet calculates all the losses of every device in the path and calculates the correct tap values.

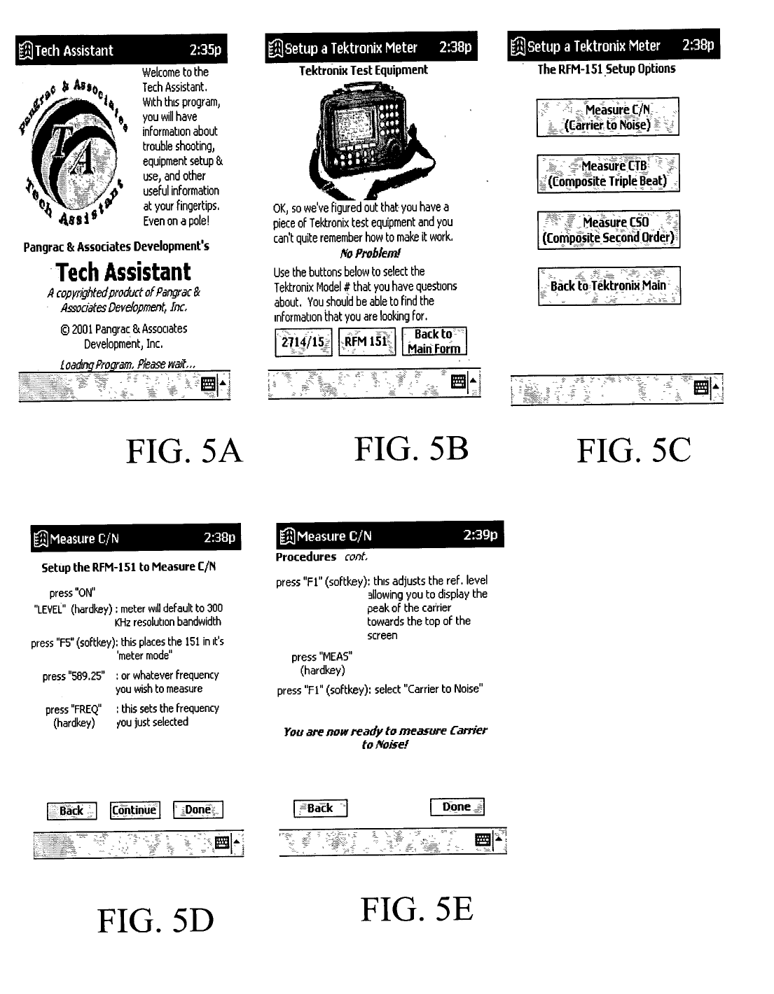

The following FIGS. 5A-5E, 6A-6B, 7A-7B, 8A-8F, 9A-9B, 10A-10B and 11A-11D are exemplary screen shots of an exemplary Tech Assistant Device according to an embodiment of the present invention. These screen shots do not include every screen shot but instead illustrate exemplary screen shots to illustrate the present invention. The screen shots are exemplary only for purposes of illustration and may be changed or modified as desired for specific needs or uses. The screen shots illustrated are appropriate for handheld type devices and would be revised for use with devices having larger displays, such as a laptop computer.

FIGS. 5A-5E are exemplary screen shot diagrams illustrating an initial splash screen (FIG. 5A) and exemplary test equipment (Tektronix RFM 151) setup information for measuring C/N. FIG. 5B illustrates selection of Test-Equipment-Use and Tektronix from the menu system and FIG. 5C illustrates selection of the Tektronix RFM-151 from the menu of FIG. 5B. FIG. 5D illustrates selection of the “Measure C/N (Carrier to Noise)” from the menu of FIG. 5C and includes setup information. The setup information is continued on FIG. 5E.

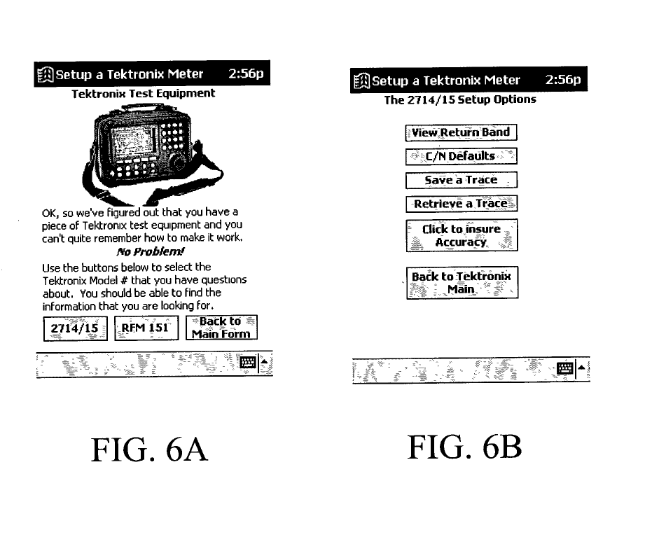

FIGS. 6A-6B are exemplary screen shot diagrams illustrating another exemplary test equipment (Tektronix 2714/15) setup information. FIG. 6A is the same screen shot as FIG. 5B and FIG. 6B illustrates selection of the “2714/15” item from the menu of FIG. 6A.

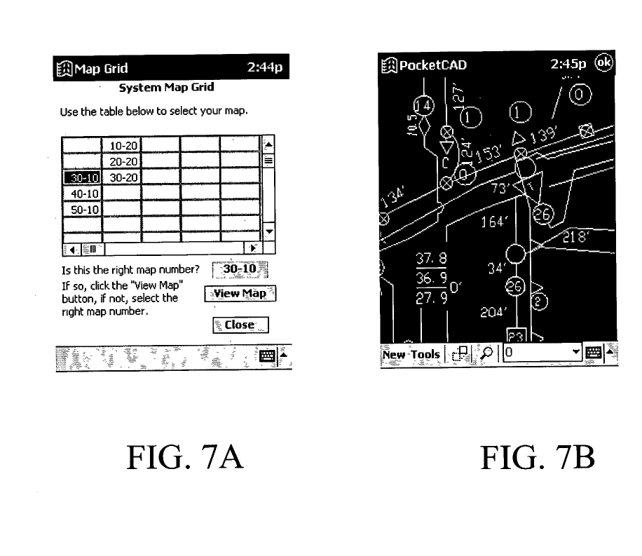

FIGS. 7A-7B are exemplary screen shot diagrams illustrating an exemplary stored System Map Grid and map portion of a specific cable plant. FIG. 7A is a table of map grids for selection and FIG. 7B is a shot of a portion of a map of grid 30-10 selected from the menu of FIG. 7A.

FIGS. 8A-8F are exemplary screen shot diagrams illustrating exemplary troubleshooting information for calculating distortions, CNR and CTB. FIG. 8A is the main “Trouble Shooting Areas” menu. FIG. 8B illustrates selection of the “Distortions” menu item of FIG. 8A and begins describing distortion calculation information. FIGS. 8C and 8D illustrate additional distortion calculation information. FIG. 8D provides an exemplary overview map including the ability to select the headend or one of several hub locations. FIG. 8E is a calculator screen shot that is displayed after selection of the “BooBoo” hub location item of FIG. 8D. FIG. 8F illustrates used of the calculator.

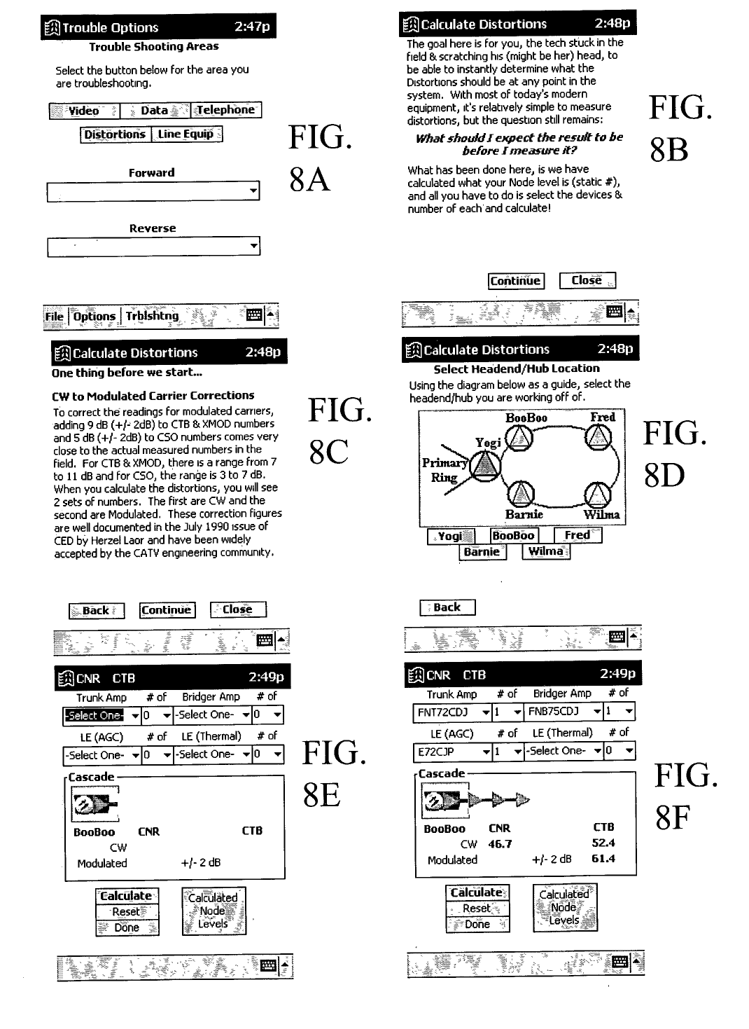

FIGS. 9A-9B are exemplary screen shot diagrams illustrating exemplary test procedure with stored C-Cor manual.

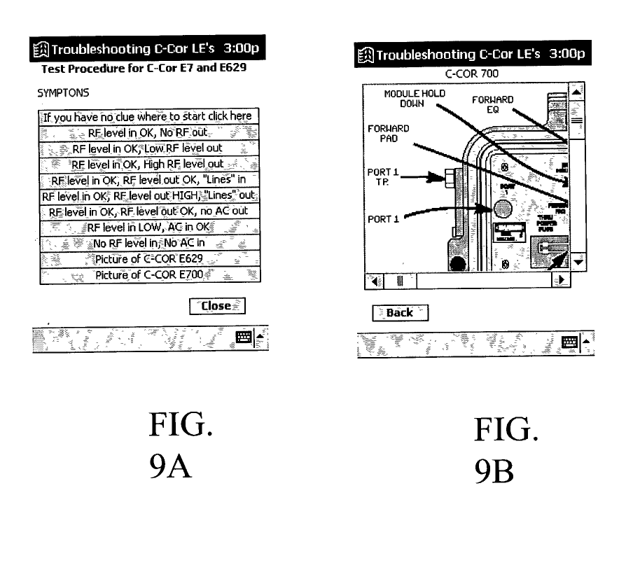

FIGS. 10A-10B are exemplary screen shot diagrams illustrating exemplary Reverse (upstream from subscriber to central location) Problems and Causes Information.

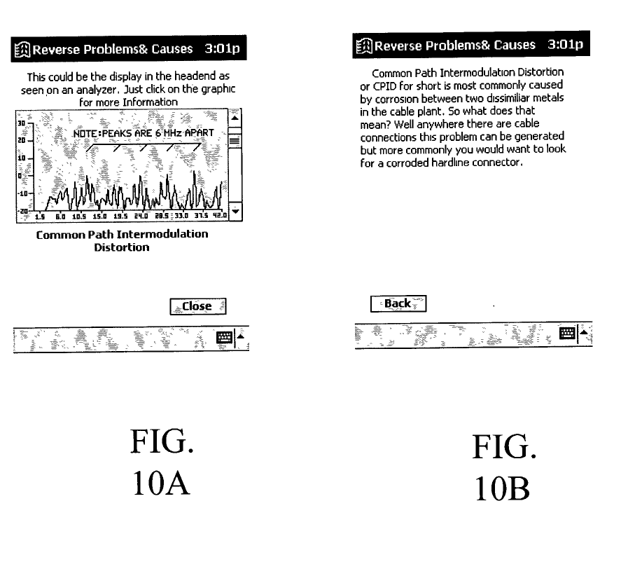

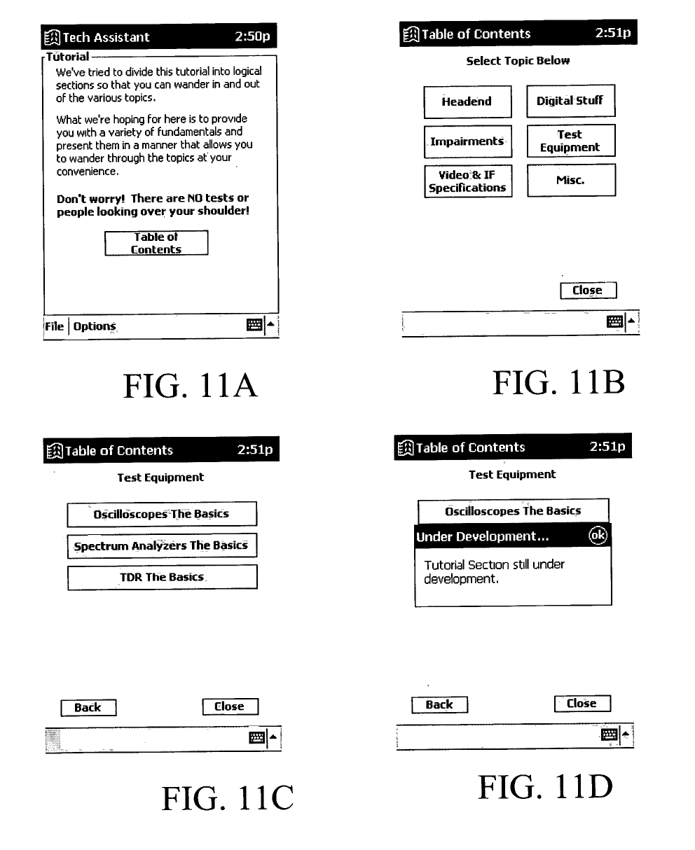

FIGS. 11A-11D are exemplary screen shot diagrams illustrating exemplary Tutorial information. FIG. 11B is the tutorial table of contents listing. FIG. 11C is the Test Equipment sub-table of contents including information for oscilloscopes, spectrum analyzers and TDRs. FIG. 11D illustrates selection of “Oscilloscopes The Basics”, although more specific tutorial information would be displayed than that illustrated.

Although a system and method according to the present invention has been described in connection with one or more embodiments, it is not intended to be limited to the specific form set forth herein, but on the contrary, it is intended to cover such alternatives, modifications, and equivalents, as can be reasonably included within the spirit and scope of the invention as defined by the appended claims.

1. An electronic device configured as a technician assistant for a field technician of a telecommunications network, comprising:
a processing device;
a memory, coupled to the processing device, that stores applications for execution by the processing device;
a technician assistant application, for loading into the memory and for execution by the processing device, that includes network-specific information combined with generic technical information to assist the technician to identify any of a plurality of network problems and to diagnose and resolve any of the plurality of network problems;
a display, coupled to the processing device and the memory that displays technician assistant selection and result information; and
at least one input device, coupled to the processing device, for selection and control of the technician assistant application.

2. The electronic device of claim 1, wherein the technician assistant application incorporates a design module that assists a field technician with creating a new network or network extension including selection of network components and cabling, input of network operating parameters and calculation of network values including tap values.

3. The electronic device of claim 1, wherein the technician assistant application incorporates a design module that includes an “as built” mode used to predict signal levels in an existing network.

4. The electronic device of claim 1, wherein the technician assistant application includes a diagnostic module that lists the plurality of network problems and that provides corresponding diagnostic and solution information for each problem.

5. The electronic technician assistant of claim 4, wherein the diagnostic module further comprises:
a video section that incorporates a plurality of common video problems and corresponding solutions;
a data section that incorporates a plurality of common high speed data problems and corresponding solutions; and
a telephony section that incorporates a plurality of common telephony problems and corresponding solutions.

6. The electronic technician assistant of claim 5, wherein the video, data and telephony sections are each organized into forward and reverse groups.

7. The electronic technician assistant of claim 4, wherein the diagnostic module further includes a distortions program for calculating amplifier distortions.

8. The electronic technician assistant of claim 1, wherein the technician assistant application includes a test equipment use module that includes information to enable the technician to setup and use selected test equipment.

9. The electronic technician assistant of claim 8, wherein the test equipment use module includes specific setup and use information for performing each of a plurality of test measurements, including taking measurements to analyze a network and how to interpret measured results.

10. The electronic technician assistant of claim 1, wherein the technician assistant application includes a specification module that provides specification and documentation information of each of a plurality of selected network components and devices.

11. The electronic technician assistant of claim 10, wherein the technician assistant application includes a map module that displays at least one selected telecommunications network map.

12. The electronic technician assistant of claim 11, wherein the specification module provides specification and documentation information of each component and device in the selected telecommunications network map.

13. The electronic technician assistant of claim 1, wherein the technician assistant application includes a map module that displays at least one selected broadband telecommunications network map.

14. The electronic technician assistant of claim 13, wherein the map module includes a zoom feature to display any selected portion of the selected broadband telecommunications network.

15. The electronic technician assistant of claim 1, wherein the technician assistant application includes a tutorial section that provides training information of at least one topic associated with broadband telecommunications.

16. The electronic technician assistant of claim 1, wherein the technician assistant application is menu-driven.

17. The electronic technician assistant of claim 16, wherein the at least one I/O device includes a touch screen sensor, coupled to the display, that enables the technician to select graphic icons on the display to navigate the technician assistant application.

18. The electronic technician assistant of claim 1, wherein the at least one I/O device includes a camera.

19. The electronic technician assistant of claim 1, wherein the at least one I/O device includes a bar-code reader.

20. The electronic technician assistant of claim 1, wherein the at least one I/O device includes a communication port that enables the technician to receive and transmit data.

21. The electronic technician assistant of claim 1, wherein the processing device, the memory, the display and the at least one I/O device are incorporated into a handheld unit.

22. A technician support application for assisting a technician supporting a broadband telecommunications network system, the technician assistant application for operating on a computer device with a display and at least one input interface, comprising:
a menu-driven main program that causes display of a main menu and that enables menu-based navigation; and
at least one technician assistant module, interfaced to the main program, that includes network-specific information combined with generic technical information to assist the technician to identify any of a plurality of network problems and to diagnose and resolve any of the plurality of network problems.

23. The technician support application of claim 22, wherein the at least one technician assistant module comprises a network design module that assists a field technician with creating a new network or network extension including selection of network components and cabling, input of network operating parameters and calculation of network values.

24. The technician support application of claim 22, wherein the at least one technician assistant module comprises a network design module that includes an “as built” mode used to predict signal levels in an existing network.

25. The technician support application of claim 22, wherein the at least one technician assistant module comprises a diagnostic module that includes a plurality of predetermined service areas and information on selected problems and corresponding solutions associated with each service area.

26. The technician support application of claim 25, wherein the diagnostic module includes forward and reverse information for each selected problem associated with each service area.

27. The technician support application of claim 25, wherein the at least one technician assistant module includes a test equipment module that provides setup and use information for at least one piece of test equipment.

28. The technician support application of claim 27, wherein the at least one technician assistant module includes a specification module that provides specifications for each of a plurality of predetermined network components.

29. The technician support application of claim 28, wherein the at least one technician assistant module includes a map module that enables selection and display of at least one network map.

30. The technician support application of claim 29, wherein the at least one technician assistant module comprises a tutorial module that includes training information about selected network concepts.

31. The technician support application of claim 30, wherein the at least one technician assistant module includes a communication module to enable remote communications.

32. A broadband telecommunication support tool, comprising:
a menu display module that displays selected pages and information;
an input module that detects input selections and that retrieves and provides selected database information to the menu display module, the menu display and input modules cooperating to provide an interactive menu-driven system;
a diagnostic database that incorporates comprehensive diagnostic information of known technical problems and corresponding solutions;
a test equipment database that incorporates comprehensive setup and operation information of selected test equipment;
a component specification database that incorporates comprehensive specification information of predetermined network components; and
a map database that incorporates display information of at least one comprehensive network map.
